(19) United States
(12) Patent Application Publication
(10) Pub. No.: US 2024/0240939 A1
(43) Pub. Date: Jul. 18, 2024

(54) Method and Device for Analyzing the Surface of a Workpiece

(71) Applicant: Siemens Aktiengesellschaft, Muenchen (DE)

(72) Inventor: Robert KAROLY, Budapest (HU)

(21) Appl. No.: 18/014,834

(22) PCT Filed: Jul. 6, 2021
(86) PCT No.: PCT/EP2021/068693

§ 371 Date: Jan. 6, 2023

(30) Foreign Application Priority Data
Jul. 9, 2020 (EP) 20184941

(51) Int. Cl. G01B 21/30; G05B 19/406

(52) U.S. Cl. CPC G01B 21/30; G05B 19/406; G05B 2219/34427

(57) ABSTRACT

A method for analyzing the surface of a workpiece which is moved along a trajectory during machining by a tool whilst simultaneously detecting at least one operating parameter comprises discrete values, wherein the trajectory is divided into a first and at least one second portion that have a course parallel to one another, and the discrete values of the at least one operating parameter are uniquely assigned to predetermined groups along the first and the at least one second portion, and where a check is then performed to determine whether the first portion is at least partly adjacent to the at least one second portion, but does not belong to the group thereof, and is classified as a surface anomaly of the workpiece.

### CROSS-REFERENCE TO RELATED APPLICATIONS

This is a U.S. national stage of application No. PCT/EP2021/068693 filed 6 Jul. 2021. Priority is claimed on European Application No. 20184941.1 filed 9 Jul. 2020, the content of which is incorporated herein by reference in its entirety.

### BACKGROUND OF THE INVENTION

### 1. Field of the Invention

The invention relates to a method and an apparatus for analyzing the surface of a workpiece which is moved along a trajectory during machining by a tool while simultaneously detecting at least one operating parameter comprising discrete values.

### 2. Description of the Related Art

With a computer-controlled machining machine with a tool, such as a Computerized Numerical Control (CNC) milling machine, it is often necessary to analyze the achieved surface quality of a manufactured workpiece.

Following manufacture of the workpiece, this frequently occurs in a conventionally visual manner that may be complex and expensive, however, due to time-consuming handling, for instance.

EP 3 623 888 A1 shows a method which, during the CNC manufacture of a workpiece, detects the temporal course of a measured, actual tool position, analyzes the variation with respect to an ideal tool position and concludes a surface quality therefrom.

### SUMMARY OF THE INVENTION

It is a object of the invention provide a method that permits an accurate surface analysis for a workpiece and in the process identification of surface anomalies that were caused during the manufacturing process in an automatic, reliable and rapid manner without subjecting the workpiece to a visual inspection.

This and other objects and advantages are achieved in accordance with the invention by a method, where a trajectory is divided into a first and at least one second portion, which have a course that is preferably partially parallel to one another, and the discrete values of the at least one operating parameter along the first and the at least one second portion are uniquely assigned to predetermined groups, and where a check is then performed to determine whether the first portion is at least partially adjacent to the at least one second portion, but does not belong to the group thereof, and is classified as a surface anomaly of the workpiece.

The inventive method makes it possible for an automatic, rapid and accurate surface analysis to be performed with an identification of surface anomalies.

Alternatively, the manufacture of the workpiece can be simulated, i.e., a virtual workpiece can be created and a surface analysis can be performed virtually before the physical manufacture is performed. Problems can therefore be identified promptly and the manufacture can be corrected accordingly.

The method provides that the machining process is electronically logged, for instance, by the computer-controlled machine and an anomaly identification is then performed on account of the movement profile and assigned detected operating parameters of the tool.

The first portion and the at least one second portion are subsets formed from the trajectory.

Data points in the form of operating parameter values form the movement of a tool along a trajectory, for instance, where the trajectory describes the local or temporal sequence of detected data points.

In other words, a portion is determined by the course of the trajectory, i.e., by the temporal sequence of the individual data points in the form of the operating parameter values, which together form the trajectory. A portion is a subset of the trajectory.

A portion contains a sequence of temporally or locally consecutive data points, independent of their respective values of the operating parameter. Data points therefore lie within portions.

On the other hand, the groups are determined by the values of the individual data points, which form the trajectory and can be defined, for instance, by threshold values that are assigned to the respective groups.

Groups comprise data points with operating parameter values, which lie in the same value range assigned to the respective group, but are independent of an assignment to a portion. A predetermined value range is therefore assigned to each group, to which value range the data points are in turn assigned.

The inventive method allocates groups and portions to data points of a trajectory, then determines the relationship between a respective group and a respective portion and derives the existence of an anomaly therefrom, if the respective data points belong to different groups, i.e., the values vary from one another to a degree which exceeds a predefined limit value.

In other words, it is established for two data points of the trajectory, whether:
the sequence of data points is not consecutive, i.e., separate portions are assigned, but consequently have an at least partially parallel course of the respective portions, and
the data points differ in amount by a value which amounts to at least the value range of a group.

In one embodiment of the invention, a check is performed to determine whether the first portion is at least partially adjacent to at least two second portions of the same group, but does not belong to the group thereof and is classified as a surface anomaly of the workpiece.

As a result, the reliability of the anomaly identification, i.e., the probability of an appropriate detection, can be further improved.

This is achieved because a check is additionally performed to determine whether the portions are locally directly adjacent to one another, i.e., lie adjacent to one another.

In an embodiment of the invention, the tool has a machining width and the at least one operating parameter is detected at supporting points along the trajectory, which supporting points along the trajectory have a distance from one another which amounts at most to half the machining width. As result, a high degree of accuracy of the method is achieved.

In another embodiment of the invention, a minimum and maximum is determined along the trajectory from the at least one operating parameter and a speed range is determined from the difference thereof, in which range the value ranges of the groups lie, which are preferably adjacent to one another. As a result, a simple group definition is achieved.

In a further embodiment of the invention, an average value is determined from the at least one operating parameter, from which average value a speed range is determined, in which range the value ranges of the groups lie, which are preferably adjacent to one another. Here, a reliable anomaly identification is achieved as a result.

In another embodiment of the invention, the assignment of the at least one operating parameter to predetermined groups is performed repeatedly and the groups to be redefined in the process. As a result, the identification rate of the method, i.e., the probability of a correct classification, can be improved.

Anomalies are to occur independently of a grouping, i.e., by the selection of predetermined value ranges.

In one embodiment of the invention, a linear distribution forms the basis of an initial definition of the groups, and a non-linear distribution is applied for a redefinition of the groups, preferably in an immediately subsequent definition. As a result, the identification rate of the method can be further improved.

In a further embodiment of the invention, at least two operating parameters are detected and different operating parameters of the at least two operating parameters are applied for a redefinition of the groups. As a result, the identification rate of the method can be further improved.

In yet another embodiment of the invention, the operating parameter is the machining speed, the machining temperature on the tool or the power consumption of the machine. As a result, a criterion is easily provided that can form the basis for the further analysis.

In another embodiment of the invention, the method is implemented after physically manufacturing the workpiece. As a result, an analysis of the surface quality is possible without physically examining the workpiece.

In a further embodiment of the invention, the method is implemented by a computing apparatus after simulating manufacture of the workpiece. A time-intensive handling of the workpiece during an inspection can therefore be avoided. As a result, an analysis of the surface quality is possible, before the workpiece is physically manufactured. An adjustment of the manufacturing process can even be accordingly performed, advantageously and easily.

It is also an object of the invention to provide a computing apparatus having a memory for analyzing the surface of a workpiece, which is configured to move the workpiece along a trajectory during its machining by a tool while simultaneously detecting at least one operating parameter via at least one sensor, where the computing apparatus is configured to execute the inventive method in accordance with the disclosed embodiments.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is explained in more detail below on the basis of an exemplary embodiment shown in the accompanying drawings, in which:

FIG. 1 shows an exemplary embodiment of a machined workpiece and workpiece trajectories in accordance with the invention;

FIGS. 2-3 show an enlarged cutout from FIG. 1;

FIGS. 4-9 show a representation of trajectories from FIG. 2 with groupings;

FIG. 10 shows an enlarged cutout from FIG. 1 with supporting points for operating parameters; and

FIG. 11 shows an exemplary flowchart of an embodiment of the inventive method.

### DETAILED DESCRIPTION OF THE EXEMPLARY EMBODIMENTS

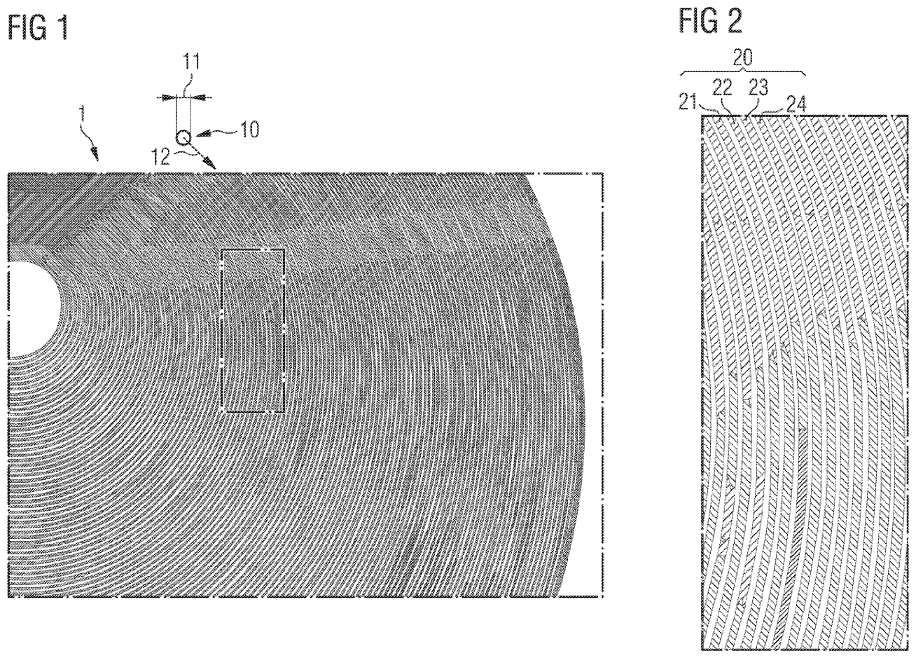

FIG. 1 shows a top view of an exemplary embodiment of a machined workpiece 1, which was machined by a computer-controlled machine such as a Computerized Numerical Control (CNC) milling machine with a tool 10 in the form of a mill.

The workpiece 1 has a surface machined in a circular manner with a mill with a three-axle kinematics.

The machining is performed in this example by a meander-shaped milling with a mill 10 with a 0.2 mm diameter 11 and advance speeds 12 of to up to 4700 mm/min.

In the course of the manufacturing plan, a trajectory 20 for the machining by the mill 10 is defined for the workpiece 1.

Although a constant speed can be provided during the planning, it may result in variations, for instance, as a result of an unfavorable runtime behavior of the controller.

Here, the movement of the workpiece 1 in the machine is predetermined with its coordinates and also the machining speed. Accordingly, the milling machine is now established to move the workpiece 1 along a trajectory 20 during its machining by the mill.

During the manufacturing process, one or more operating parameters 12, such as the machining speed, the machining temperature on the tool 10 or the power consumption of the machine, is detected by a corresponding sensor in each case.

A computing apparatus with a memory is now used to carry out the surface analysis of the workpiece 1 after machining by the computer-controlled machine with the tool.

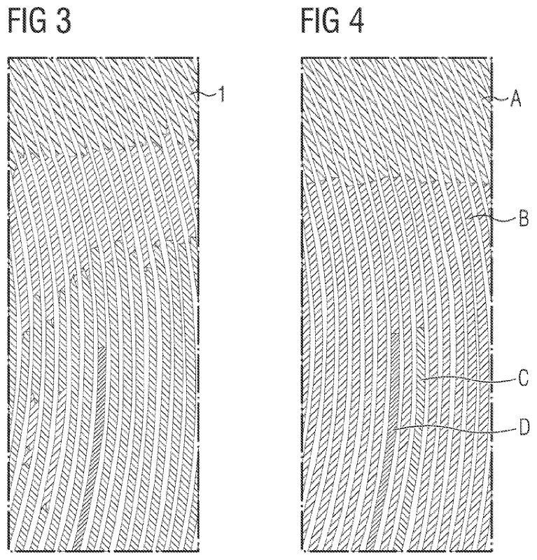

FIG. 2 and FIG. 3 represent an enlarged cutout from FIG. 1. The trajectory 20 is divided into portions 21-24 that have a course parallel to one another. The course can be straight or also curved for instance, as in a turn of the tool 10 for material removal on a surface of the workpiece 1.

The values of the detected operating parameter 12, here the advance speed, is then assigned to predetermined groups A-D along the portions 21-24.

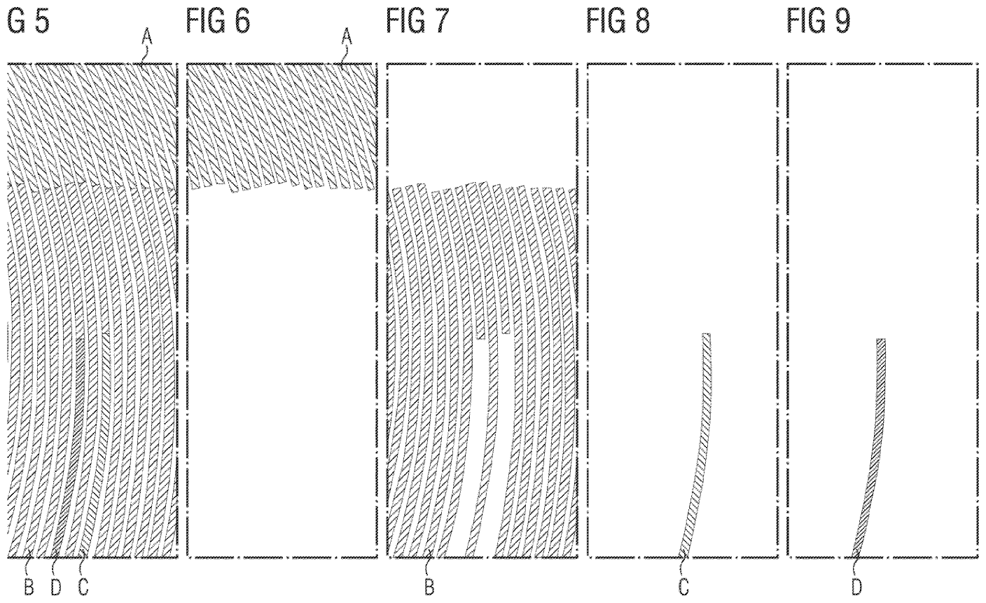

FIG. 4 to FIG. 9 show the trajectory 20 with the portions 21-24 from FIG. 2 with groupings A-D for predetermined value ranges of the operating parameter 12.

Groups are defined for the grouping, to which groups the respective operating parameter 12 can be assigned on account of its value.

The determination of the groups can occur, for instance, such that a minimum and a maximum is determined along the trajectory 20 from the operating parameter 12.

A speed range can then be determined from the difference between the maximum and minimum, in which speed range the value ranges of the groups A-D lie.

In the simplest case, the groups A-D can be adjacent to one another, but gaps can also be provided for known values, which are expressly not to be included, such as when the mill is idling in the event of changes in position or changes in configuration during operation of the CNC machine.

Alternatively, an average value can also be determined from the operating parameter 12.

A speed range for the value ranges of the groups A-D can be defined for adjacent groups from the average value using a statistical distribution function, for instance, which groups must largely not be of the same size.

Combinations of the cited group definitions can also be applied.

Portions in the groups A-D can be seen in FIG. 4 and FIG. 5.

The trajectory 20 is divided into a first portion 22 and a second portion 21, which have a course parallel to one another.

The first portion 22 and the second portion 21 are subsets of the portions 21-24.

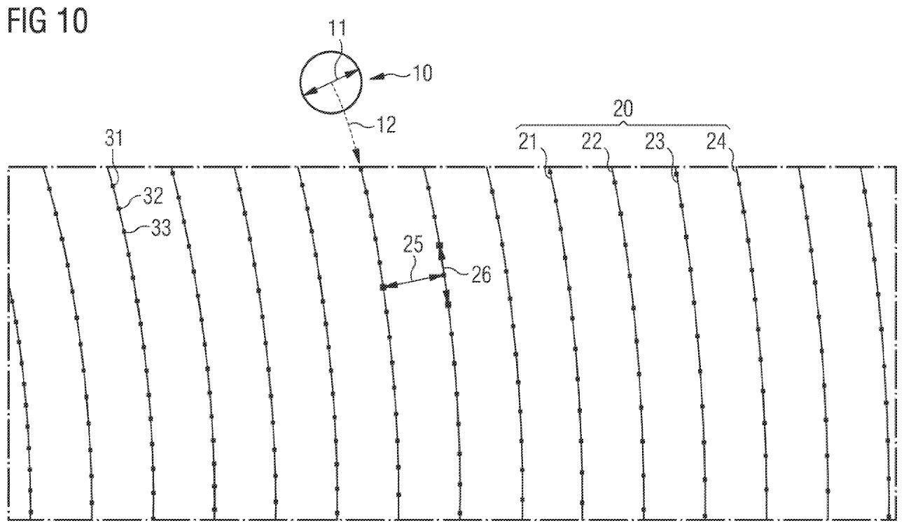

The discreet values 31-33, see FIG. 10, of the operating parameter 12 along the first and the at least one second portion 21-24 are uniquely assigned to predetermined groups A-D.

A check is then performed to determine whether the first portion 22 is at least partially adjacent to the second portion 21, but does not belong to the group B thereof. If so, the second portion 21 is identified or classified as a surface anomaly of the workpiece 10.

Optionally, as a further improvement to the method, a check can additionally be made to determine whether the first portion 22 is at least partially adjacent to two second portions 21 and 23 of the same group B, but does not belong to the group B thereof. If so, then the second portion 21 is identified or classified as a surface anomaly of the workpiece 10.

In FIG. 6 only those portions are shown, which extend parallel to other regions of the trajectory 20 and are in the same group A for the advance speed.

In FIG. 7 only those portions are shown, which extend parallel to other regions of the trajectory 20 and are in the same group B for the advance speed.

In FIG. 8 only that portion is shown, which extends parallel to other regions of the trajectory 20 and is in group C for the advance speed.

In FIG. 9 only that portion is shown, which extends parallel to other regions of the trajectory 20 and is in group D for the advance speed.

A portion 21-24 that is adjacent but does not belong to the same group A-D is determined as a surface anomaly of the workpiece 10.

Adjacent portions 21-24 may then exist, for instance, if the respective portions make mutual contact with the machining width 11 along the trajectory 20 or at least partially overlap and the portions 21-24 are consequently directly adjacent to one another.

A trajectory of this type is then provided, for instance, if material is milled from a workpiece blank to manufacture a flat surface of the workpiece.

Alternatively, a trajectory of this type can also then be provided, for instance, if material is milled from a workpiece blank, in order to manufacture grooves that extends parallel in the workpiece. In this way, grooves that extend parallel can likewise form adjacent portions 21-24, even if a further molding of the workpiece occurs between the grooves.

FIG. 10 shows an enlarged cutout from FIG. 1 with supporting points for the detection site of the operating parameter 12.

The portions of the trajectory 20 extend parallel to one another at a distance 25.

The distance 25 is selected in this example such that the milling paths overlap with the machining width 11 and as a result a complete material removal is ensured.

The selection of the supporting points is, in most cases, determined for the operating parameter 12 by the scanning rate of a detection system.

It is clear that by way of example a possible advance speed of the mill 10 is to be considered here.

The supporting points for the detection of the operating parameter 12 result in corresponding values 31-33.

The supporting points can be selected, for instance, by the operating parameter 12 being detected at supporting points along the trajectory 20 and the supporting points along the trajectory 20 having a supporting point distance 26 from one another which amounts at most to half the machining width 11.

The tool 10 determines the machining width 11 in most cases by the diameter of the mill.

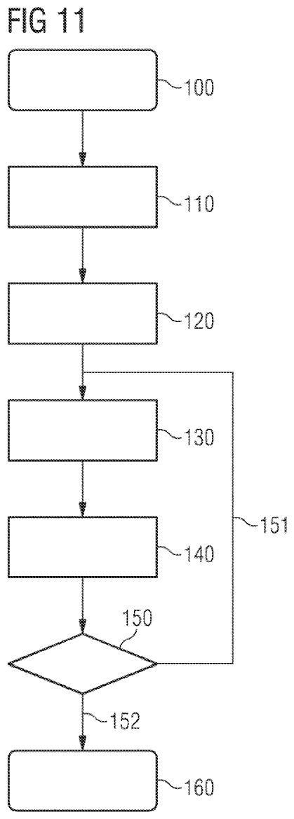

FIG. 11 shows an exemplary flowchart of an embodiment of the inventive method.

After a start 100, the workpiece 1 is manufactured in accordance with a manufacturing plan, or a manufacture is also only simulated. Here, the respective positions of the mill 10 and the mill speeds 12 along the trajectory 20 are detected.

The manufacturing data for the workpiece 1 can be stored in a log file, for instance.

An analysis of the manufacturing data subsequently occurs. Here, the trajectory 20 in step 120 is divided into portions 21-24, which have a slightly curved course that extends parallel to one another.

Then, in a step 130, groups are defined and the values of the detected operating parameter 12 along the portions 21-24 are assigned to predetermined groups A-D in a step 140.

A check then occurs on an anomaly 150. The anomaly check 150 determines whether the first portion 22 is at least partially adjacent to the at least one second portion 21, but does not belong to the group B thereof.

Optionally, a check can be implemented to determine whether the first portion 22 is adjacent at least partially to two, or also several, second portions 21 and 23 of the same group B, but does not however belong to the group B thereof.

If applicable, the first portion 22 is identified or classified as a surface anomaly of the workpiece 10.

If the check 150 shows that no anomaly has been identified, a repetition of the analysis can optionally now occur via a step 151 or can be terminated by step 160.

The assignment of the operating parameter 12 to predetermined groups A-D can be performed repeatedly, where the groups are redefined. Here, at least one previously defined number of identified surface anomalies of the workpiece 10 can be determined as a criterion for the repetitions, or until a predetermined number of redefinitions of groups A-D is reached.

A linear distribution can form the basis of an initial definition of groups A-D, and a non-linear distribution can be applied to a redefinition of groups A-D, in a directly following definition, for instance.

Two or more operating parameters 11 can also be detected and different operating parameters can be applied in each case for a redefinition of groups A-D in each case.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-12. (canceled)

13. A method for analyzing the surface of a workpiece which is moved along a trajectory during machining of the workpiece by a tool while simultaneously detecting at least one operating parameter comprising discrete values, the method comprising:
dividing the trajectory into a first and at least one second portion, which have a course parallel to one another, the discrete values of the at least one operating parameter being uniquely assigned to predetermined groups along the first and the at least one second portion; and
performing a check to determine whether the first portion is at least partially adjacent to the at least one second portion, but does not belong to the group thereof, and is classified as the surface anomaly of the workpiece.

14. The method as claimed in claim 13, further comprising:
performing a check to determine whether the first portion is at least partially adjacent to at least two second portions of the same group, but does not belong to the group thereof and is classified as a surface anomaly of the workpiece.

15. The method as claimed in claim 13, wherein the tool has a machining width and the at least one operating parameter is detected at supporting points along the trajectory, said supporting points along the trajectory having a distance from one another which amounts at most to half the machining width.

16. The method as claimed in claim 13, wherein a minimum and a maximum is determined from the at least one operating parameter along the trajectory and a speed range is determined from the difference thereof, in which speed range the value ranges of the groups lie which are adjacent to one another.

17. The method as claimed in claim 13, wherein an average value is determined from the at least one operating parameter, from which a speed range is determined, in which speed range the value ranges of the groups lie, which are adjacent to one another.

18. The method as claimed in claim 13, wherein the assignment of the at least one operating parameter to predetermined groups is performed repeatedly, and in the process the groups are redefined.

19. The method as claimed in claim 13, wherein a linear distribution forms a basis of an initial definition of the groups and a non-linear distribution is applied for a redefinition of the groups in a directly subsequent definition.

20. The method as claimed in claim 17, wherein at least two operating parameters are detected and different operating parameters of the at least two operating parameters are applied for a redefinition of the groups.

21. The method as claimed in claim 18, wherein at least two operating parameters are detected and different operating parameters of the at least two operating parameters are applied for a redefinition of the groups.

22. The method as claimed in claim 13, wherein the operating parameter comprising one of (a) a machining speed, (ii) a machining temperature on the tool and (iii) a power consumption of the machine.

23. The method as claimed in claim 13, wherein the method is implemented after a physically manufacturing the workpiece.

24. The method as claimed in claim 13, wherein the method is implemented after simulating manufacture of the workpiece via a computing apparatus.

25. A computing apparatus comprising:
a memory for analyzing a surface of a workpiece which is moved along a trajectory during machining of the workpiece by a tool while simultaneously detecting at least one operating parameter is detected via at least one sensor;
wherein the computing apparatus is configured to:
divide the trajectory into a first and at least one second portion, which have a course parallel to one another, the discrete values of the at least one operating parameter being uniquely assigned to predetermined groups along the first and the at least one second portion; and
perform a check to determine whether the first portion is at least partially adjacent to the at least one second portion, but does not belong to the group thereof, and is classified as the surface anomaly of the workpiece.
